(19) United States
(12) Patent Application Publication
(10) Pub. No.: US 2025/0347503 A1
(43) Pub. Date: Nov. 13, 2025

(54) DISTANCE MEASURING DEVICE FOR USE IN MEASURING A STANDARD DISTANCE DURING A SPORTING CONTEST

(71) Applicant: Franklin L. McLean, West Windsor, NJ (US)

(72) Inventor: Franklin L. McLean, West Windsor, NJ (US)

(73) Assignee: Franklin L McLean, West Windsor, NJ (US)

(21) Appl. No.: 18/658,807

(22) Filed: May 8, 2024

(51) Int. Cl. G01B 3/1071; A63B 71/06; G01B 3/1005; G01B 3/1056

(52) U.S. Cl. CPC G01B 3/1071; A63B 71/06; G01B 3/1005; G01B 3/1056; A63B 2220/20; A63B 2243/0025; G01B 2003/103; G01B 2003/1074

(57) ABSTRACT

A sports measuring device to measure a standard distance during a sporting contest comprises a casing, a reel mounted in the casing, and a measuring cord wound around the reel and extending outwardly through an aperture in the casing. When entirely unwound from the reel with a distal end being tautly extended away from the first end of the casing, a length of the measuring cord between the distal end and a plane defined by the first end of the casing equals the standard distance defined by a specific rule of play of the sporting contest. The device further comprises an anchoring assembly partially disposed inside the casing and permitting movement of a retractable ground spike between a stored position and an extended position, the extended position enabling the retractable ground spike to be affixed to a ground surface of a field of play of the sporting contest during use.

### BACKGROUND OF THE INVENTION

### Field of the Invention

The present disclosure relates generally to a measuring device for use during and pursuant to the rules of a sporting contest, and more particularly, a measurement device configured for use by a referee in the sport of soccer to measure a predetermined distance.

### Description of the Related Art

Within the sport of soccer, or football as it is more widely known outside of the United States, game regulations define that a free kick requires any opponents to be positioned at least ten (10) yards from a spot position of the ball. Typically, the referee will place the ball at the spot position, pace (walk) an approximate distance of ten yards, and indicate this distance. Therefore, this regulatory distance has become somewhat arbitrary and at the whim of any given referee, particularly given that referees differ in height and associated stride lengths. Accordingly, to more closely comply and standardize game rules, there exists a need for an improved device to aid in the accuracy of this distance measurement.

### SUMMARY OF THE INVENTION

Various embodiments of a sports measuring device to measure a standard distance during a sporting contest are described herein. In one embodiment, the sports measuring device comprises a casing including a front side, a back side opposite the front side, a top side, a bottom side opposite the top side, a first end, and a second end opposite the first end; a reel mounted in the casing; and a measuring cord wound around the reel.

The measuring cord includes a distal end extending through an aperture in the first end of the casing, and when entirely unwound from the reel with the distal end being tautly extended away from the first end of the casing, a length of the measuring cord between the distal end and a plane defined by the first end of the casing equals the standard distance defined by a specific rule of play of the sporting contest.

The sports measuring device further comprises an anchoring assembly partially disposed inside the casing and permitting movement of a retractable ground spike between a stored position and an extended position. When in the extended position, the retractable ground spike fully extends through an aperture and a plane defined by the bottom side of the casing to affix the sports measuring device to a ground surface of a field of play of the sporting contest during use.

The foregoing summary has been provided to introduce a selection of concepts in a simplified form that are further described below in the detailed description. The summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front view illustration of a sports measuring device in an in-use configuration, according to one embodiment of the present invention;

FIG. 2 is a rear view illustration of the sports measuring device in the in-use configuration, according to one embodiment of the present invention;

FIG. 3 is a side view illustration of the sports measuring device in the in-use configuration, according to one embodiment of the present invention;

FIG. 4 is an additional side view illustration of the sports measuring device in the in-use configuration, according to one embodiment of the present invention;

FIG. 5 is a bottom view illustration of the sports measuring device, according to one embodiment of the present invention;

FIG. 6 is a plan view illustration of a sports measuring device, according to one embodiment of the present invention;

FIG. 7 is a front perspective view illustration of the sports measuring device in the in-use configuration, according to one embodiment of the present invention;

FIG. 8 is a rear perspective view illustration of the sports measuring device in the in-use configuration, according to one embodiment of the present invention;

FIG. 9 is a rear perspective view illustration of the sports measuring device in a partially in-use configuration, according to one embodiment of the present invention;

FIG. 10 is a front perspective view illustration of the sports measuring device in a partially in-use configuration, according to one embodiment of the present invention; and

FIG. 11 is a front-interior view illustration of the sports measuring device, according to one embodiment of the present invention.

### DETAILED DESCRIPTION OF THE DRAWINGS

The following detailed description of the invention merely provides exemplary embodiments and is not intended to limit the invention of the application and uses of the invention. Furthermore, there is no intention to be bound by any theory presented in the preceding background of the invention of the following detailed description of the invention.

As mentioned previously, within the sport of soccer (“football1” outside the United States), game regulations define that a free kick requires any opponents to be positioned at least ten (10) yards from a spot position of the ball. The longstanding typical procedure to effect this penalty award consists of the referee placing the ball at the spot position, pace (walk) an approximate distance of ten yards, and indicate this distance. Therefore, the standard regulatory distance has become somewhat arbitrary and at the whim of any given referee, particularly given that referees differ in height and associated stride lengths.

It is well-known that teams of any sport, particularly professional teams, go to great lengths to tilt even the slightest game advantage in their favor, as oftentimes the most competitive or championship-type games are decided by one or a culmination of small yet consequential plays or foul awards. It would therefore be advantageous for game officials or referees to access a small and lightweight measuring device which consistently and accurately indicates this standard distance, defined by game regulations, to “level the playing field” among players and teams, while portraying a sense of fairness in the officiating of the game to attendees and viewers.

Accordingly, certain embodiments of the present invention relate to a small, lightweight and portable measuring device which is quickly and easily utilized in a sporting contest (game) by a single game official to accurately measure the standard distance (i.e., ten (10) yards) of space that game regulation specifies must be placed between a player and a spot of the ball, prior to restarting play of the game and allowing an opposing player a free kick.

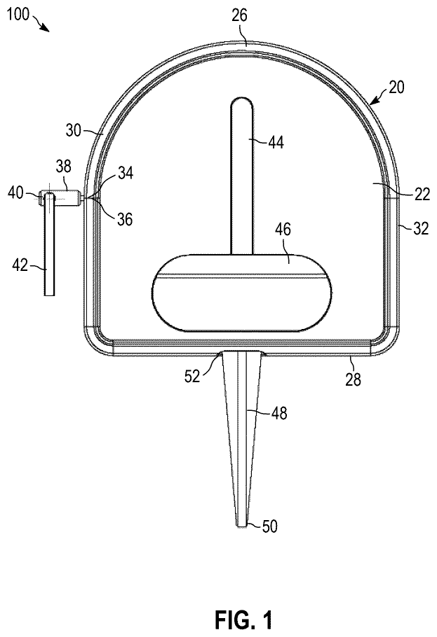

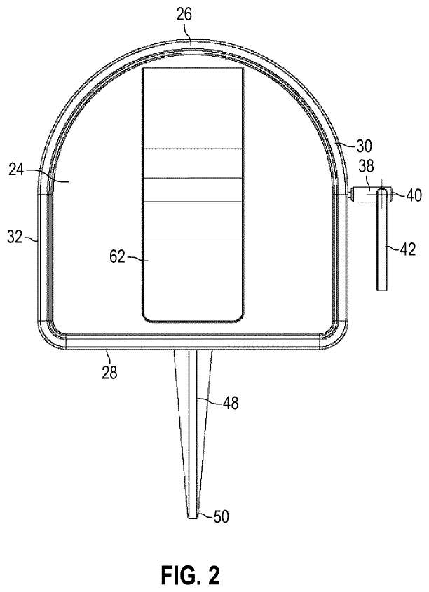

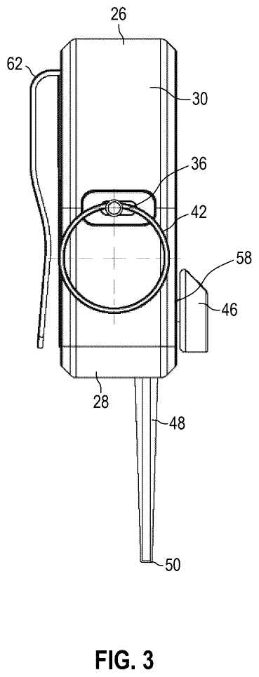

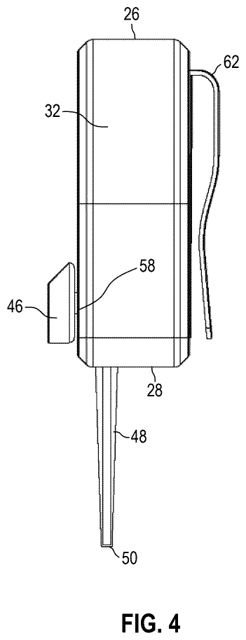

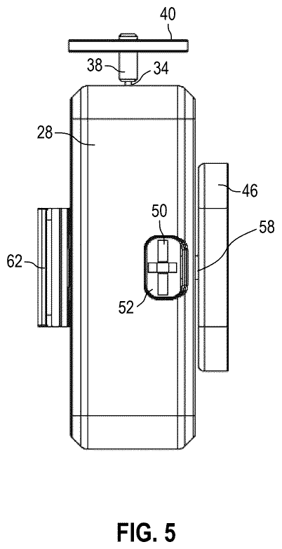

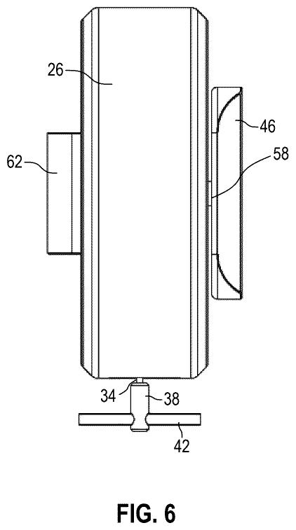

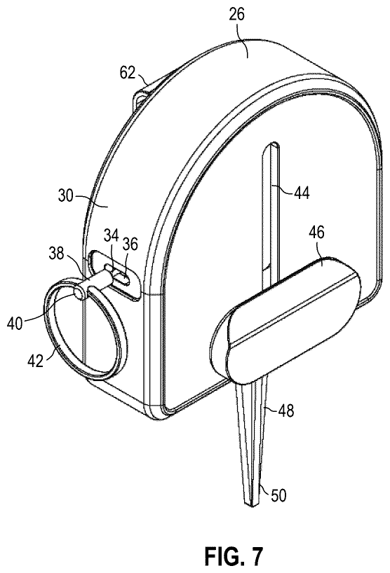

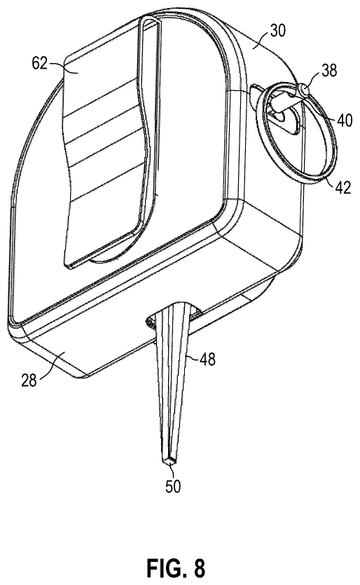

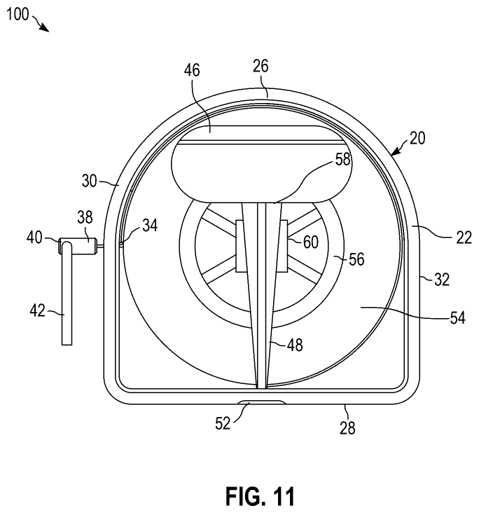

Referring now to the Figures, FIG. 1 to FIG. 11 show a sports measuring device (also referred to herein as simply “measuring device”) 100. The measuring device 100 may include an outer casing or housing 20 defined by one or more outer walls. The casing 20 may generally define a front side 22, a back side 24 opposite the front side 22, a top side 26, a bottom side 28 opposite the top side 26, a left edge (or side) 30, and a right edge (or side) 32 opposite the left edge 30.

In one embodiment, the casing 20 is constructed of a durable polymer or synthetic polymer, such as polyvinyl chloride (PVC), silicon or plastic, and may include an outer coating formed from a natural or synthetic non-slip material to protect the measuring device 100 from environmental elements and frequent outdoor use. In the depicted embodiment, the top side 26 of the casing 20 is arched vertically to join the left edge 30 and the right edge 32 to ergonomically form the top side 26 for ease of holding in a user's hand. Further, each longitudinal edge of the top side 26, left edge 30, right edge 32, and bottom side 28 may be chamfered at the point that each edge meets the front side 22 and the back side 24 of the casing 20 for similar hand feel. The casing 20 may additionally be constructed from one or more materials having or having been painted with one or more colors which enable the casing 20 to contrast (or blend) with a field of play of the sporting contest. In another embodiment, the casing 20 may be formed of one or more colors representing a particular team, event or the like.

The casing 20 may include an aperture 36, or horizontal slot, through which a distal end of a measuring cord 34 extends therethrough. In one embodiment, the measuring cord 34 is constructed of a durable polymer or synthetic polymer, such as nylon. The distal end of the measuring cord 34 may be capped with an end cap 38, which may be larger in diameter than the aperture 36. This dimension enables the end cap 38 to maintain the distal end of the measuring cord 34 exterior to the casing 20, and act as a stop from allowing the distal end of the measuring cord 34 to pass through the aperture 36. The end cap 38 may itself contain an aperture 40, of which a finger ring 42 is passed through to enable the user to pull the measuring cord 34 from the casing 20. The aperture 40 may be formed in the end cap 38 to be large enough in diameter to allow the finger ring 42 to rotate or pivot according to its angle of use. In one embodiment, the end cap 38 and/or the finger ring 42 may be constructed from a metal, metal alloy or non-metal (e.g., a polymer).

The measuring cord 34, beginning at a proximal end, may be secured to and wound around a reel 54 disposed inside the casing 20. The reel 54 may be attached to the back side 24 of the casing 20 by a rod or axle 60, thereby allowing the reel 54 to rotate about its axis. In another embodiment, the reel 54 may engage with the axle 60 which is secured to both the front side 22 and the back side 24 of the casing 20. In still another embodiment, the reel 54 may engage with the axle 60 secured via vertical member(s) to the top side 26 and/or the bottom side 28 of the casing 20.

In one embodiment, the reel 54 may be connected to a clock spring 56 (also known as a “flat coil spring”), and utilize a torsion principle to achieve retraction of the measuring cord 34. In its initial state, the measuring device 100, when retracted, houses the clock spring 56 in its most tightly coiled configuration, thereby storing potential energy. As the user extends the measuring cord 34 through the aperture 36, the clock spring 56 begins to unwind, exerting a restoring torque that pulls inward and creating a controlled resistance against the user's pull-out force. When disengaged, the stored energy of the clock spring 56 is released, during which the clock spring 56 rewinds itself and consequently retracts the measuring cord 34 at a controlled pace due to the inherent torque. In one embodiment, the clock spring 56 is constructed of a durable metal or metal alloy to withstand the attendant tension placed thereon.

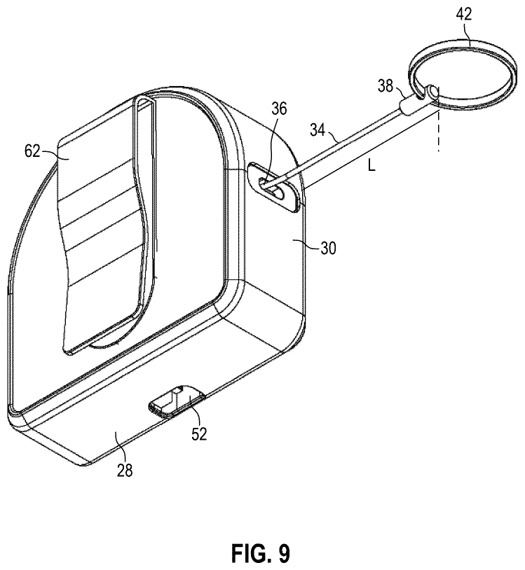

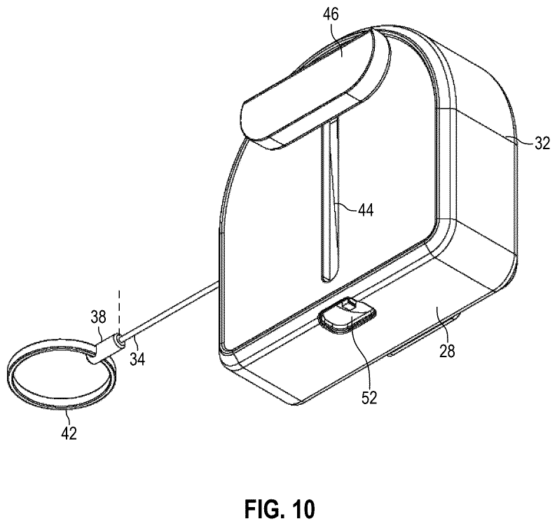

In the depicted configuration (shown in FIGS. 9 and 10), the measuring cord 34 is constructed to, at its maximum extension away from the casing 20, have a predetermined length L as measured from a distal end of the end cap 38 (or, in another embodiment, a center of the finger ring 42) to a line defined by the left edge 30 of the casing 20. This predetermined length L of the measuring cord 34 is selected according to a specific pre-existing rule or regulation in a game of sport, namely, the ten (10) yard free kick rule defined in the game of soccer/football. Accordingly, the predetermined length L of the measuring cord 34 (as measured from the distal end of the end cap 38 to the line defined by the left edge 30 of the casing 20), when extended to its maximum distance at which point the measuring cord 34 is fully unwound from the reel 54 and stopped from extending any further, equals the standard distance defined by the soccer/football free kick regulation of ten (10) yards.

It should be noted, however, that a total constructed length of the measuring cord 34 may be greater than the standard distance (e.g., 10.1 yards) to accommodate the necessary securement of the measuring cord 34 to the reel 54, while also accounting for any intermediate space between the reel 54 and the left edge 30 of the casing 20. It should be additionally noted that the measuring cord 34 is configured to measure a distance of objects at the standard distance (and only the standard distance) based on the length of its maximum extension away from the casing 20. Therefore, the measuring cord 34 is entirely devoid and free of any distance measurement markings or indications.

In an embodiment, the casing 20 may contain a vertical slot 44 on the front side 22, and an aperture or horizontal slot 52, in the bottom side 28. These sections of the casing 20 enable the selective use of an anchoring assembly partially disposed within the casing 20. The anchoring assembly may include a retractable ground spike 48 which, when in an extended position, anchors the measuring device 100 to the field of play of the sporting contest by allowing the user to affix the measuring device 100 to the ground surface of the playing field while the user extends the measuring cord 34 outwardly to measure the standard distance. The ground spike 48 may be constructed of a durable metal, metal alloy or non-metal, and be formed as a vertically-grooved rod, which is tapered beginning at a proximal end (nearest the top side 26) and narrowing at a distal end 50.

The anchoring assembly may further include a longitudinal member 58, of which a first end engages the proximal end of the retractable ground spike 48 at an end interior to the casing 20, extends through the vertical slot 44, and of which a second end engages a proximal end of a finger tab 46 exterior to the casing 20. The finger tab 46, which is positioned parallel to the front side 22 of the casing 20 and oriented perpendicular to the vertical slot 44, actuates the anchoring assembly to selectively cycle between two use positions, stored and extended.

The finger tab 46 may be defined by any shape and size so long as the finger tab 46 enables the actuation of the retractable ground spike 48, and does not interfere with the use or storage of the measuring device 100. In the depicted embodiment, the finger tab 46 is of an oblong shape having a relatively thin longitudinal depth to maintain the overall depth of the measuring device 100 as thin as practical. A vertically-upper end of the finger tab 46 may be beveled or chamfered to allow the user to easily identify and depress the tab between the two use positions without direct observation, and the finger tab 46 may be constructed of a durable polymer or synthetic polymer, such as a non-slip silicon.

In a stored position (depicted in FIGS. 9-11), the retractable ground spike 48 is entirely disposed within the casing 20, such that the distal end 50 does not pass through a line defined by the bottom side 28. In this stored position, the finger tab 46 is positioned at an upper stop of the vertical slot 44 with the longitudinal member 58 maintaining the proximal end of the retractable ground spike 48 at an upper portion of the casing 20. When placed in this configuration, the user (i.e., game official) may store the measuring device 100 on their person, such as on their belt by utilizing the belt hook 62 attached to the back side 24 of the casing 20. The belt hook 62 may be constructed of a durable metal, metal alloy or non-metal, and be U-shaped to engage the user's belt, as one of ordinary skill in the art would appreciate.

When needed for use, the anchoring assembly, from its stored position, may be placed in an extended position (depicted in FIGS. 1-8) by the user on the fly (e.g., as the game official is walking up to the spot of the foul). The user places the anchoring assembly in the extended position by pressing the finger tab 46 downward with a force parallel to the casing 20. This downward force on the finger tab 46 slides the finger tab 46 downward within the vertical slot 44, acting upon the longitudinal member 58 to actuate and extend the retractable ground spike 48 through the aperture 52 in the bottom side 28 of the casing 20. At the point at which the longitudinal member 58 is stopped by the lower end of the vertical slot 44, the retractable ground spike 48 is fully extended and ready to be affixed to the ground surface of the playing field.

In operation, the user plunges the distal end 50 of the retractable ground spike 48 into the field of play to temporarily anchor the assembly, measures the standard distance by pacing back the measuring cord 34 until it reaches its maximum extension, and indicates this spot on the field (e.g., by spraying a line of foam at the spot on the field or by another visual indication). Once the spot has been accurately measured, the user paces forward to retract the measuring cord 34 back into the casing 20, as the clock spring 56 rewinds itself and consequently retracts the measuring cord 34 to its stoppage point by the end cap 38 contacting the aperture 36. The user then removes the measuring device 100 from the field of play, and fully retracts the retractable ground spike 48 back into the casing 20 by moving the finger tab 46 upward until the longitudinal member 58 stops (by engaging the upper end of the vertical slot 44) the finger tab 46 from moving upward further. The measuring device 100 may then be stored by the user for subsequent use.

In one embodiment, the retractable ground spike 48 is maintained in the stored position or the extended position by a friction fit of the finger tab 46, longitudinal member 58, and proximal end of the retractable ground spike 48 holding tension among the front side 22 and/or back side 24 of the casing 20. In another embodiment, the retractable ground spike 48 is maintained in the stored position or the extended position by a notch formed within an upper and/or lower end of the vertical groove 44 which catches the longitudinal member 58 in a particular vertical position, or through similar means.

In an embodiment, the measuring device 100 may further be configured to include an apparatus (not depicted) which distributes spray-foam, allowing the user to indicate the marking of the standard distance by the user. This apparatus may be integrated into, or constructed in place of, the finger ring 42. For example, the finger ring 42 may be coupled to (or omitted in place of) a device holding a can of aerosolized foam, which the user may use to designate the spot at the standard distance on the field of play after its measurement.

In an embodiment, the measuring device 100 may further be configured with an onboard computing system (not depicted), such as a System-on-a-Chip (SoC), which is integrated into the casing 20. This SoC may include a processor (including processing circuitry and cache), communication fabric, volatile memory, persistent storage, and a network module to communicate with a remote server (e.g., the Cloud). In certain aspects, the SoC may include sensors to monitor a geographic location (via a Global Positioning System (GPS) module) of the device and/or perform analytics on data obtained with respect to its use.

For example, the SoC may utilize GPS, Accelerometer, Gyroscope, Magnetometer, Barometer, and/or Proximity sensors integrated into the casing 20 to detect and identify trends or patterns related to game foul activities. Game data may be obtained by one or more of these sensors, and this data may be transmitted, via the network module, to the remote server to perform processing to obtain statistical or other information which may aid in game analysis.

In another example, the measuring device 100 may include sensors such as a camera and/or microphone integrated into the casing 20. These sensors may be utilized by the SoC to provide audio and/or video data to the remote server for game purposes.

It should be noted that, as used herein, the terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A sports measuring device to measure a standard distance during a sporting contest, comprising:
a casing including a front side, a back side opposite the front side, a top side, a bottom side opposite the top side, a first end, and a second end opposite the first end;
a reel mounted in the casing;
a measuring cord wound around the reel, the measuring cord including a distal end extending through an aperture in the first end of the casing, wherein, when entirely unwound from the reel with the distal end being tautly extended away from the first end of the casing, a length of the measuring cord between the distal end and a plane defined by the first end of the casing equals the standard distance defined by a specific rule of play of the sporting contest; and
an anchoring assembly partially disposed inside the casing and permitting movement of a retractable ground spike between a stored position and an extended position, wherein, when in the extended position, the retractable ground spike fully extends through an aperture and a plane defined by the bottom side of the casing to affix the sports measuring device to a ground surface of a field of play of the sporting contest during use.

2. The sports measuring device of claim 1, further comprising a clock spring coupled to the reel, wherein the clock spring maintains a retractable tension on the measuring cord.

3. The sports measuring device of claim 1, wherein the retractable ground spike, when in the stored position, is fully disposed within the casing and does not extend through the plane defined by the bottom side of the casing.

4. The sports measuring device of claim 1, wherein the front side of the casing includes a vertical slot.

5. The sports measuring device of claim 4, wherein the anchoring assembly includes a longitudinal member partially disposed within the casing and extending through the vertical slot and a vertical plane defined by the front side of the casing.

6. The sports measuring device of claim 5, wherein a first end of the longitudinal member is fixed to a proximal end of the retractable ground spike within the casing, and a second end of the longitudinal member is coupled to a finger tab disposed parallel to the front side of the casing and oriented perpendicular to the vertical slot.

7. The sports measuring device of claim 6, wherein, when the retractable ground spike is in the stored position, the finger tab is positioned at an upper end of the vertically-oriented slot.

8. The sports measuring device of claim 7, wherein, when a downward force is applied to the finger tab, the finger tab engages the longitudinal member to slide downward within the vertical slot to actuate and extend the retractable ground spike through the aperture in the bottom side of the casing, wherein the retractable ground spike is in the extended position when the sliding member is stopped by a bottom end of the vertical slot.

9. The sports measuring device of claim 8, wherein the finger tab is constructed of a non-slip silicon material.

10. The sports measuring device of claim 1, wherein the anchoring assembly is configured to maintain the retractable ground spike in the stored position by a friction fit.

11. The sports measuring device of claim 1, further comprising a belt hook coupled to the back side of the casing, and configured to selectively mount the sports measuring device to a user's belt.

12. The sports measuring device of claim 1, further comprising an endcap attached to the distal end of the measuring cord, wherein the endcap includes an aperture.

13. The sports measuring device of claim 12, further comprising a finger ring coupled to the endcap through the aperture, wherein the finger ring is utilized by a user to extend the measuring cord.

14. The sports measuring device of claim 13, wherein the finger ring is constructed of a metal or metal alloy.

15. The sports measuring device of claim 1, wherein the retractable ground spike, when in the stored position, does not extend through the plane defined by the bottom side of the casing.

16. The sports measuring device of claim 1, wherein the retractable ground spike is vertically-grooved, and tapered beginning at a proximal end and narrowing to the distal end.

17. The sports measuring device of claim 1, wherein the retractable ground spike is constructed of a metal or metal-alloy.

18. The sports measuring device of claim 1, wherein the measuring cord is constructed of a nylon material.

19. The sports measuring device of claim 1, wherein the measuring cord is devoid of any measurement indicators.

20. The sports measuring device of claim 1, wherein a color of the casing is selected based on a visibility of the sports measuring device to contrast the field of play of the sporting contest.
